(19) United States
(12) Patent Application Publication
(10) Pub. No.: US 2021/0157698 A1
(43) Pub. Date: May 27, 2021

(54) Method, System, Storage Media And Device For Stress Test Of Baseboard Management Controllers

(71) Applicants: Inventec (Pudong) Technology Corporation, Shanghai (CN); Inventec Corporation, Taipei City (TW)

(72) Inventor: Bao-Dong Song, Shanghai (CN)

(21) Appl. No.: 16/822,602

(22) Filed: Mar. 18, 2020

(30) Foreign Application Priority Data
Nov. 22, 2019 (CN) 201911155424.4

(51) Int. Cl. G06F 11/26; G06F 11/22; G06F 8/61

(52) U.S. Cl. CPC G06F 11/26; G06F 8/61; G06F 11/2284; G06F 11/2221

(57) ABSTRACT

Method, system, storage medium and device for stress test of the baseboard management controllers are provided. In the method, serial numbers of servers under test and physical addresses of baseboard management controllers of the servers under test are acquired and stored. The baseboard management controllers are determined according to the stored serial numbers and the physical addresses, and the stress test is performed on the baseboard management controllers of the servers under test based on multi threads in one-to-one correspondence. Therefore, the technical effect of remotely performing the stress tests on the baseboard management controllers of the servers in batches can be achieved.

### CROSS-REFERENCE TO RELATED APPLICATION

This application claims the benefit of Chinese Application Serial No. 201911155424.4, filed Nov. 22, 2019, which is hereby incorporated herein by reference in its entirety.

### BACKGROUND OF THE INVENTION

### Field of the Invention

The present invention relates to a communication method, a communication system, a storage medium and device, and more particularly to a method, a system, a storage medium and a device for a test method of baseboard management controllers.

### Description of the Related Art

With the rapid development of the server industry, remote control functions of servers are becoming more and more important to customers, and it is necessary to ensure stability of the remote control functions of servers in batch delivery. A conventional method uses an Intelligent Platform Management Interface (IPMI) to control, test and verify servers one by one through baseboard management controllers (BMCs) during a stress test. The conventional method is relatively simple but has low efficiency.

Therefore, what is needed is to develop an improved technical solution to solve the conventional technical problem that the efficiency of performing the stress test on baseboard management controllers of the servers in batch delivery is a key issue in the industry.

### SUMMARY OF THE INVENTION

An objective of the present invention is to provide a method, system, storage medium and device for stress test of baseboard management controllers, so as to solve the conventional technical problem that the efficiency of performing the stress test on the baseboard management controllers of the servers in batches is low.

In order to achieve the objective, the present invention provides a system for stress test of the baseboard management controllers, and the system includes an acquisition module for acquiring serial numbers of servers under test and physical addresses of baseboard management controllers of the servers under test; a storage module for storing the serial numbers of the servers under test and the physical addresses of the baseboard management controllers of the servers under test; a test module for determining the baseboard management controllers according to the serial numbers of the servers under test and the physical addresses of the baseboard management controllers of the servers under test, and performing stress test on the baseboard management controllers of the servers under test based on multi threads in one-to-one correspondence.

In order to achieve the objective, the present invention further provides a method for a stress test of the baseboard management controller, and the method comprises steps of: acquiring serial numbers of servers under test and physical addresses of baseboard management controllers of the servers under test; storing the serial numbers and the physical addresses; and determining the baseboard management controllers according to the serial numbers and the IP addresses, and performing stress tests on the baseboard management controllers of the servers under test based on multi threads in one-to-one correspondence.

In order to achieve the objective, the present invention further provides a computer-readable storage medium for storing a computer program, and when the computer program is executed by a processor, the aforementioned method for stress test of the baseboard management controllers can be implemented.

In order to achieve the objective, the present invention further provides a device for stress test of the baseboard management controllers, and the stress test device includes a processor and a storage medium, and the storage medium stores a computer program, and the processor is connected to the storage medium and executes the computer program, so that the device can execute the aforementioned method for stress test of the baseboard management controllers.

According to above-mentioned contents, the difference between the conventional technical and the present invention is that the technical solution of the present invention can acquire the serial numbers of the servers under test and the physical addresses of the baseboard management controllers of the servers under test, and then store the serial number and the physical address of the server under test, and next, determine the baseboard management controller according to the serial numbers of the servers under test and the physical addresses of the baseboard management controllers of the servers under test, and perform stress tests on the baseboard management controllers of the servers under test based on multi threads in one-to-one correspondence, so as to solve conventional technical problem, and achieve the technical effect of remotely performing the stress tests on the baseboard management controllers of the servers in batches.

### BRIEF DESCRIPTION OF THE DRAWINGS

The structure, operating principle and effects of the present invention will be described in detail by way of various embodiments which are illustrated in the accompanying drawings.

FIG. 1a is a schematic structural view of a server, according to an embodiment of the present invention.

FIG. 1b is a flowchart of an embodiment of a method for stress test of baseboard management controllers, according to the present invention.

FIG. 2 is a schematic structural view of an embodiment of a system for stress test of baseboard management controllers, according to the present invention.

FIG. 3 is a schematic structural view of an embodiment of a device for stress test of baseboard management controllers, according to the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be acknowledged that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the word “comprise”. “include” and “have”, and variations such as “comprises”, “comprising”, “includes”, “including”, “has” and “having” will be acknowledged to imply the inclusion of stated elements but not the exclusion of any other elements.

A method, system, storage medium and device for stress test of baseboard management controllers according to the present invention can remotely perform the stress test on the baseboard management controllers of the servers in batches.

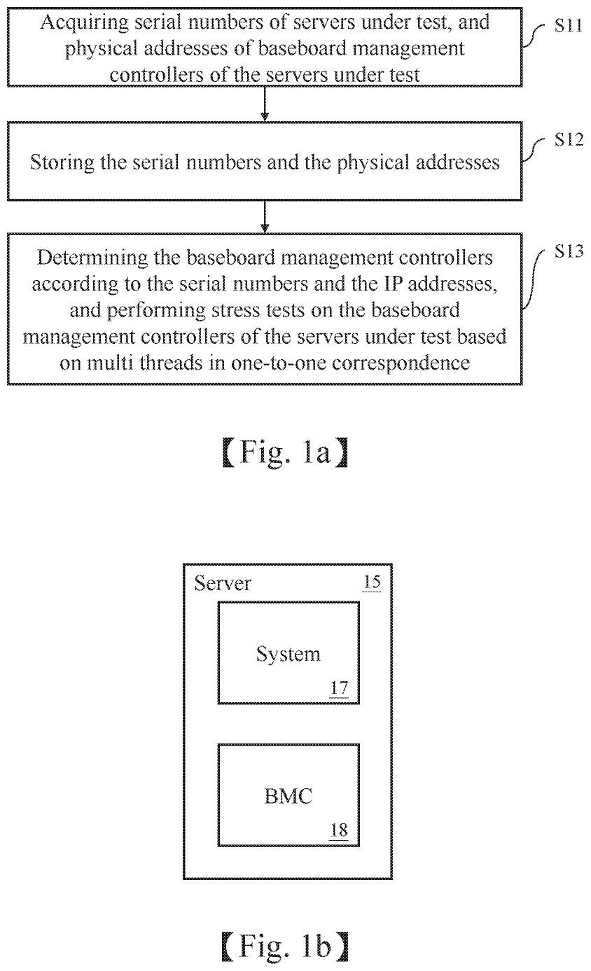

Please refer to FIG. 1a in an embodiment, the method for stress test of the baseboard management controllers according to the present invention, includes steps S1 to S13.

In the step S11, serial numbers of servers under test, and physical addresses or logical addresses of baseboard management controllers of the servers under test are acquired. Particularly, the physical address can be a media/medium access control address, which is abbreviated as MAC address; the logical address can be an interest protocol address, which is abbreviated as IP address. The IP address is a uniform address format provided by the internet protocol which allocates a logical address for each network and each host in interest, to mask differences between the physical addresses.

Particularly, the server under test is a unit under test, abbreviated as UUT. The serial number is a product serial number, and can be abbreviated as SN and sometimes called as Serial No. Please refer to FIG. 1b, which shows a structure of a baseboard management controller 18 and a system 17 on a server 15. FIG. 1b also shows the structure of the server 15 under test. The baseboard management controller can support the intelligent platform management interface defined in industry standard, which is abbreviated as IPMI and can intelligent monitor, control and automatically report operational status of a large quantity of servers across different operating systems, firmware and hardware platforms. The IPMI regulation describes management functions built-in the motherboard. The management functions include, but not limited to, local and remote diagnosis, console support, allocation management, hardware management and troubleshooting.

Particularly, the step of acquiring the serial numbers of the servers under test and the IP addresses of the baseboard management controllers can be implemented by any one of following manners of: acquiring the serial numbers and the IP addresses of the baseboard management controllers by a packet broadcast manner through a dynamic host configuration protocol; or receiving the serial numbers and the IP addresses of the baseboard management controllers transmitted from the servers under test, through a transmission control protocol. The dynamic host configuration protocol is abbreviated as DHCP and is a network communication protocol of a local area network, and uses UDP to work; the DHCP has mainly two purposes, one is for an intranet or network service vender to automatically allocate IP address to client-end devices, and the other is for a user or intranet system administrator to perform central management for all client-end devices. The transmission control protocol can be abbreviated as TCP and is an interconnect-oriented, reliable and byte-flow-based transport layer communication protocol; in a simplified computer network OSI model, the TCP completes the functions assigned by the fourth transport layer, and in the internet protocol suite, the TCP layer is disposed above the IP layer and is an intermediate layer below the application layer. The application layers of different hosts need to be connected reliably like pipes, the IP layer cannot provide this data flow mechanism, but the TCP layer can provide the reliable packet switching mechanism.

Particularly, the step of acquiring the serial numbers and the IP addresses of the baseboard management controllers by the packet broadcast manner through the DHCP is to receive a MAC address of the baseboard management controller of each of the servers under test transmitted by the packet broadcast manner through the DHCP. Transmitting the IP address to each server under test through the DHCP based on the MAC address of the baseboard management controllers of servers under test is to acquire the serial numbers and the IP addresses of the baseboard management controllers by the packet broadcast manner through DHCP.

Particularly, the step of acquiring the serial numbers and the IP addresses of the baseboard management controllers by the packet broadcast manner through DHCP, can be implemented based on the following codes:

filePath=‘udpdata.format’
bc_addr=‘255.255.255.255’
content=CommonMethod.readFile(filePath)
pack=bytearray(content)
dp=DHCPPack(pack)
dst_port=dp.DHCPServerPort
timeout=2
bind_address=
bind_port=dp.DHCPClientPort
mac=mac.replace(‘-’,″)
mac=mac.upper( )
dp.setClientEthernetAddress(CommonMethod.hexStringToBytes(mac))
dp.setClientIP(CommonMethod.hexStringToBytes(“00000000”))
dp.setFlags(CommonMethod.hexStringToBytes(“8000”))
dp.setMsgType(CommonMethod.hexStringToBytes(“01”))
dp.setOPCode(CommonMethod.hexStringToBytes(“01”))
dp.setTransactionID(CommonMethod.hexStringToBytes(mac[8:12]))
truereplys=[ ]
replys=dhcpclient.request(dp.pack, bc_addr, dst_port, timeout, bind_address, bind_port)
for reply in replys:
rp=DHCPPack(reply)
#get the first IP from DHCP
if rp.getTransactionID( )=dp.getTransactionID( ):
   bmcpip=CommonMethod.byesToStr(rp.getMyIP( ),‘.’, 10)
   logging.debug(‘GetIp=% s’% bmcpip)

Particularly, the step of receiving the serial numbers and the IP addresses of the baseboard management controllers transmitted from the servers under test through TCP, can includes following manners. When the MAC addresses of the baseboard management controllers of the servers under test cannot be received by the packet broadcast manner through DHCP, the serial numbers and the IP addresses of the baseboard management controllers transmitted from the servers under test can be directly received through TCP. Particularly, the serial numbers and the IP addresses of the baseboard management controllers transmitted from the servers under test can be received through TCP, based on an ipmi tool. For example, the ipmi tool is ipmitool, and ipmitool can be operated by a command line manner in an operation system such as Linux, to implement functions of acquiring information of sensors, displaying content of the system log, powering on/off remotely through network.

In the step S12, the serial numbers, and the physical addresses or the logical addresses are stored. In an embodiment, the step S12 can include manner of installing preset software based on the serial numbers, and the logical addresses or the physical addresses of the baseboard management controllers.

Particularly, the preset software can be Python, the step of storing the serial numbers, and the MAC addresses and/or IP addresses of the baseboard management controller can be performed by Python. The serial numbers and the MAC addresses and/or IP addresses of the baseboard management controllers are recorded in xml format by Python.

Particularly, the step of installing the preset software based on the stored serial numbers and the MAC addresses or IP addresses of the baseboard management controllers based on software, can be implemented based on the following codes:

<unitDataList>
<uutsn>CKVE397T00K</uutsn>

<entry>

<string>bmcip</string>
<string>192.168.100.47</string>

</entry>
<entry>

<string>bmcmac</string>
<string>3868DD07C884</string>

</entry>

<uutsn>CKVE397T00M</uutsn>

<entry>

<string>bmcip</string>
<string>192.168.100.50</string>

</entry>
<entry>

<string>bmcmac</string>
<string>3868DD07C868</string>

</entry>

</unitDataList>

In the step S13, the baseboard management controllers are determined according to the serial numbers, and the physical addresses or the logical addresses, and the stress tests are performed on the baseboard management controllers of the servers under test based on multi threads in one-to-one correspondence.

Particularly, in a condition that the serial numbers and the MAC addresses or IP addresses can be determined, the baseboard management controllers can be determined uniquely. Therefore, the baseboard management controllers can be determined based on the serial numbers, and the MAC addresses or the IP addresses, and in a condition that the baseboard management controllers can be determined, the stress tests can be performed on the baseboard management controllers of the servers under test based on multi threads in one-to-one correspondence.

Particularly, the multi threads class (such as threading.Thread) of Python can be used to execute the stress tests, in one-to-one correspondence and in parallel, on the baseboard management controllers of the servers under test. Particularly, in each thread, a command (such as cmd) recoreded in a configuration is read first, and a variable (such as $nodeip$) of the command is replaced by the stored MAC address or the IP address of the baseboard management controller, and os.system(cmd) method is used to execute the command read from the configuration, and an execution result generated after the os.system( ) executes the command is recorded in the log file, so as to achieve the effect of using IPM to perform stress tests on the baseboard management controllers in batches. As a result, automation of performing the stress tests on the baseboard management controllers in batches can be implemented, thereby improving production capacity and ensuring stable performance of the baseboard management controllers of the servers when shipped the servers in bulk.

Particularly, the stress test can comprise at least one of following tests of: performing a power-on/off stress test on the baseboard management controller, and performing a basic information access stress test on the baseboard management controller. The power-on/off stress test is performed for a predetermined period and by a preset frequency. For example, the power-on/off stress test is performed for the predetermined period of ten hours, and by a preset frequency of every five minutes. Therefore, the production capacity and stable performances of the baseboard management controller of the server in batch delivery can be improved.

Particularly, the power-on/off stress test of the baseboard management controller can be implemented by following codes in the configuration file, such as power_ctrl.ini, wherein $nodeip$ is the variable which can be replaced by the MAC address or the IP address of the baseboard management controller:

[poweroff]
cmd=ipmitool.exe-I lan-H $nodeip$-U admin-P admin power off
[poweron]
cmd=ipmitool.exe-I lan-H $nodeipS-U admin-P admin power on

Particularly, the stress test is performed for the predetermined period and by the preset frequency; that is, the stress test is continuously performed for the predetermined period and by the preset frequency, and every time the stress test performed within the predetermined period and by the preset frequency is successfully, the baseboard management controller is determined to pass the stress test. Particularly, a loop can be used to repeatedly issue a command to the baseboard management controller within the predetermined period and by the preset frequency, to acquire the execution result of the command and the status information of the baseboard management controller, and to collect at least one log file of the stress test, and the stress test is stopped when failure of acquiring the log file or one or more error messages are recorded in the log file. Furthermore, when failure of acquiring the log file or the log file records error occurs, an alarm is transmitted to a preset email box or a terminal or a console, to remind a user owning the email box or the terminal/console to perform correction or repair. After the user finishes process of correcting or repairing, the stress test must be performed again until every stress test is passed. In other words, after the user corrects or repairs, the stress test is continuously performed on the baseboard management controller for predetermined period and by the preset frequency, and only every stress test is successfully within the predetermined period and by the preset frequency, the baseboard management controller is determined to pass the stress test.

Particularly, performing the basic information access stress test on the baseboard management controller includes a step of accessing basic information (info) and status information of the baseboard management controller, and the status information includes field replacement unit (FRU) list, system event log (SEL), lan channels (LAN), status data and allowable items of the baseboard management controller (MC), or monitoring items and detected monitoring values of a sensor (SDR).

Particularly, the basic information access stress test is continuously performed on the baseboard management controller within the predetermined period and by the preset frequency. For example, the basic information access stress test can be continuously performed within the predetermined period of one hour and by the preset frequency of every 30 seconds.

Particularly, performing the basic information access stress test on the baseboard management controller can be implemented based on following codes to access, for example, the FRU information:

[INFO] 2019-09-18 11:53:41, 667 PYBMC_CMD tool get info by ipmitool
[INFO] 2019-09-18 11:53:41, 667 loop is 1
[INFO] 2019-09-18 11:53:42, 105 node ipmiip:[‘10.191.4.89’]
[INFO] 2019-09-18 11:53:42, 105 exe cmd ipmitool.exe-I lan-H 10.191.4.89-U admin-P admin fru

### [INFO] 2019-09-18 11:53:46,260

### FRU Device Description: Builtin FRU Device(ID 0)

### Chassis Type: Rack Mount Chassis

### Chassis Part Number: F62M2.92

### Chassis Serial: CKHG38BV004

### Chassis Extra: AliType=F62M2.92.C0V1P0U1

### Board Mfg Date: Fri Nov 30 00:00:00 2018

### Board Mfg: Inventec

### Board Product: TB600G4

### Board Serial: GP8BNP0064

### Board Part Number: 1395T2873808

### Product Manufacturer: Inventec

### Product Name: AliServer-Thor2-01-2U

### Product Part Number: WG2480000008

### Product Version: A01

### Product Serial: CKHG38BV004

### Product Asset Tag:

When the acquired log file contains:

### FRU Device Description: Builtin FRU Device (ID 0)

### Chassis Type: Rack Mount Chassis

### Chassis Part Number: F62M2.92

### Chassis Serial: CKHG38BV004

### Chassis Extra: AliType=F62M2.92.C0V1P0U1

### Board Mfg Date: Fri Nov 30 00:00:00 2018

### Board Mfg: Inventec

### Board Product: TB600G4

### Board Serial: GP8BNP0064

### Board Part Number: 1395T2873808

### Product Manufacturer: Inventec

### Product Name: AliServer-Thor2-01-2U

### Product Part Number: WG2480000008

### Product Version: A01

### Product Serial: CKHG38BV004

### Product Asset Tag:

it indicates a success of one basic information access stress test, and particularly, the stress test of accessing the FRU information. The stress test is determined to be passed only every basic information access stress test continuously performed within the predetermined period and by preset frequency is passed successfully.

Particularly, performing the basic information access stress test, for example, access Ian information, on the baseboard management controller can be implemented based on following codes:

[INFO] 2019-09-18 11:53:46, 260 ret=1, cmd=ipmitool.exe-I Ian-H 10.191.4.89-U admin-P admin fru >getfru.log
[INFO] 2019-09-18 11:53:46, 276 exe cmd ipmitool.exe-I lan-H 10.191.4.89-U admin-P admin Ian print 1

### [INFO] 2019-09-18 11:53:47, 026

### Set in Progress: Set Complete

### Auth Type Support: MD5

### Auth Type Enable: Callback: MD5

### :User: MD5

### :Operator: MD5

### :Admin: MD5

### :OEM: MD5

### IP Address Source: DHCP Address

### IP Address: 10.191.4.89

### Subnet Mask: 255.255.252.0

### MAC Address: 08:94:ef:7d:61:e0

### SNMP Community String: Inventec

### IP Header: TTL=0x40 Flags=0x40 Precedence=0x00 TOS=0x10

### BMC ARP Control: ARP Responses Enabled, Gratuitous ARP Disabled

Gratituous ARP Intrvl: 0.0 seconds

### Default Gateway IP: 10.191.4.1

### Default Gateway MAC: 00:00:0c:07:ac:5b

### Backup Gateway IP: 0.0.0.0

### Backup Gateway MAC: 00:00:00:00:00:00

### 802.1q VLAN ID: Disabled

### 802.1q VLAN Priority: 0

### RMCP+ Cipher Suites: 0,1,2,3,6,78,11,12,15,16,17

Cipher Suite Priv Max: caaenanaananXXX

### :X=Cipher Suite Unused

:c=CALLBACK
:u=USER
:o=OPERATOR
:a=ADMIN

### :O=OEM

[INFO] 2019-09-18 11:53:47, 026 ret=0, cmd=ipmitool.exe-I Ian-H 10.191.4.89-U admin-P admin lan print 1>getlanprint.log
[INFO] 2019-09-18 11:53:47, 026 deal_with_one_node:ipmi ip:10.191.4.89, ret=0 ******log end: 4908-4768:PYBMC_IPMICMD ******

When the acquired log file contains:

### Set in Progress: Set Complete

### Auth Type Support: MD5

### Auth Type Enable: Callback: MD5

### User: MD5

### Operator: MD5

### Admin: MD5

### :OEM: MD5

### IP Address Source: DHCP Address

### IP Address: 10.191.4.89

### Subnet Mask: 255.255.252.0

### MAC Address: 08:94:ef:7d:61:e0

### SNMP Community String: Inventec

### IP Header: TTL=0x40 Flags=0x40 Precedence=0x00 TOS=0x10

### BMC ARP Control: ARP Responses Enabled, Gratuitous ARP Disabled

Gratituous ARP Intrvl: 0.0 seconds

### Default Gateway IP: 10.191.4.1

### Default Gateway MAC: 00:00:0c:07:ac:5b

### Backup Gateway IP: 0.0.0.0

### Backup Gateway MAC: 00:00:00:00:00:00

### 802.1q VLAN ID: Disabled

### 802.1q VLAN Priority: 0

### RMCP+Cipher Suites: 0,1,2,3,67,811,12,15,16,17

Cipher Suite Priv Max: caaaannXX

### :X=Cipher Suite Unused

:c=CALLBACK
:u=USER
:o=OPERATOR
:a=ADMIN

### :O=OEM

, it indicates a success of one basic information access stress test, particularly, the stress test for accessing the Ian information. The stress test is determined to be passed only every basic information access stress test continuously performed within the predetermined period and by preset frequency is passed successfully. Obviously, if all of the long-term and high-frequency tests are performed manually, it costs a lot of manpower therefore, technical solution of the present invention can reduce labor cost and improve yield rate of the servers under test in delivery.

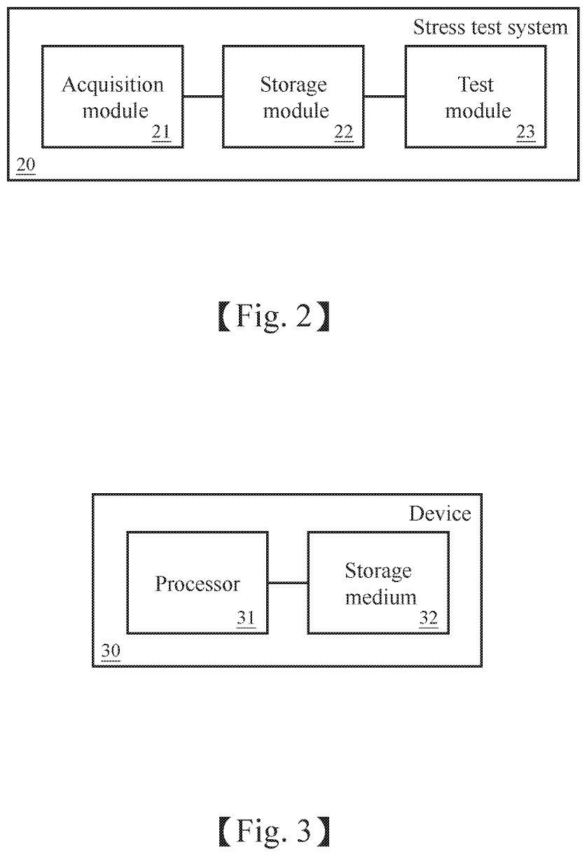

Please refer to FIG. 2. In an embodiment of the present invention, the system 20 for stress test of baseboard management controllers, can comprise an acquisition module 21, a storage module 22, and a test module 23.

The acquisition module 21 can acquire serial numbers of servers under test, and physical addresses or logical addresses of baseboard management controllers of the servers under test.

The storage module 22 can store the serial numbers, and the physical addresses or the logical addresses.

The test module 23 can determine the baseboard management controller according to the serial numbers, and the physical addresses or the logical addresses, and then perform stress tests on the baseboard management controllers of the servers under test based on multi threads in one-to-one correspondence.

It should be noted that structures and principles of the acquisition module 21, the storage module 22, and the test module 23 correspond one-to-one to steps of the method for stress test of the baseboard management controller, so detailed descriptions are not repeated.

It will further be understood that the division of the modules of the above-mentioned system is a division of logic functions, and in actual application, a part or all of the modules can be integrated into a physical device or can be separated physically. Furthermore, these modules can be implemented in the form of using software to call process devices, or can be implemented by hardware, or some of the modules are implemented in form of using software to call process devices and some of the modules are implemented by hardware. For example, an x module can be implemented by a discrete process device, or a chip integrated on the above-mentioned device; furthermore, the x module can be a program code stored in storage medium such as the memory of the aforementioned device, and can be called and executed by a certain process device of the aforementioned device to perform the function of the x module. The implementation of other module is similar to the x module. Furthermore, all or a part of these modules can be integrated together, or be implemented independently. The process device can be an integrated circuit having signal processing capability. During the implementation process, the steps of the above-mentioned method or the above-mentioned modules can be completed by integrated hardware logic circuits of a processor device or by commands in the form of software executed in the processor device.

For example, these modules can be one or more integrated circuit for implementing the above-mentioned method, for example, the one or more integrated circuit can be one or more application-specific integrated circuit (ASIC), one or more digital signal processor (DSP), or one or more field programmable gate array (FPGA). Furthermore, when the certain module is implemented in the form of using the process device to call the program code, the process device can be a general-purpose processor, such as a central processor (CPU) or other processor capable of calling program code. Furthermore, these modules can be assembled in a system-on-a-chip (SOC).

According to an embodiment of the present invention, the present invention further provides a computer readable storage medium for storing a computer program, and when the program is executed by a processor, any one of the steps of the aforementioned method for a stress test can be implemented.

One of ordinary skill in the art can comprehend that the all or a part of the steps of the embodiment of the method can be implemented by hardware related to the computer program. The computer program can be stored in a computer readable storage medium. The program can be executed to perform the steps of the embodiment of the method of the present invention. In an embodiment, the aforementioned storage medium can be a read-only memory, (ROM), a random access memory (RAM), a disk, an optical disk, or other volatile or non-volatile storage medium for storing program code.

Please refer to FIG. 3. In an embodiment of the present invention, the device 30 for stress test of the baseboard management controller, can comprise a processor 31 and a storage medium 32. The storage medium 32 can store a computer program, and the processor 31 is connected to the storage medium 32 and can execute the computer program stored in the storage medium 32, so that the device can execute any one of the steps of the method for a stress test of the baseboard management controller.

Particularly, the device for stress test of the baseboard management controller can be a server test unit under test, abbreviated as STU; the processor 31 provides a STU control service for the server test unit under test.

Particularly, the storage medium 32 can be a read-only memory, a random access memory, a disk, a flash memory/disk, a memory card, an optical disk, or other volatile or non-volatile storage medium for storing program codes.

Preferably, the processor 31 can be a general-purpose processor such as a central processor, a network processor (NP), a digital signal processor, an ASIC, an FPGA or other programmable logic components, discrete gates or transistor logic, or discrete hardware components.

According to above-mentioned contents, the difference between conventional technology and the present invention is that technical solution of the present invention can acquire the serial numbers of the servers under test and the IP addresses of the baseboard management controllers of the servers under test, store the serial numbers and the IP addresses of the servers under test, and determine the baseboard management controllers according to the serial numbers of the servers under test and the IP addresses of the baseboard management controllers of the servers under test, and then perform the stress tests on the baseboard management controllers of servers under test based on multi threads in one-to-one correspondence. By the technical solution of the present invention, the conventional technical problem of low efficiency of performing stress test on the baseboard management controllers of the servers can be solved, and the technical effect of remotely performing the stress test on the baseboard management controllers of the servers in batches can be achieved. As a result, according to the present invention, the method, system, storage medium and device for stress test of the baseboard management controllers can remotely perform the stress tests on the baseboard management controllers of the servers in batches. The present invention effectively overcomes the conventional technical problem and has high industrially applicability.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A method for stress test of baseboard management controllers, comprising:
acquiring serial numbers of servers under test, and physical addresses of baseboard management controllers of the servers under test;
storing the serial numbers and the physical addresses; and
determining the baseboard management controllers according to the serial numbers and the physical addresses, and performing stress tests on the baseboard management controllers of the servers under test based on multi threads in one-to-one correspondence.

2. The method according to claim 1, wherein the step of acquiring the serial numbers of the servers under test, and the physical addresses of the baseboard management controllers of the servers under test, comprises any one of steps:
acquiring the serial numbers and the physical addresses of the baseboard management controllers by a packet broadcast manner through a dynamic host configuration protocol; and
receiving the serial numbers and the physical addresses of the baseboard management controllers transmitted from the servers under test, through a transmission control protocol.

3. The method according to claim 1, wherein the step of storing the serial numbers and the physical addresses comprises:
installing preset software based on the serial numbers and the physical addresses of the baseboard management controllers.

4. The method for a stress test according to claim 1, wherein the stress test comprises at least one of steps:
performing a power-on/off stress test on the baseboard management controllers; and
performing a basic information access stress test on the baseboard management controllers.

5. A system for stress test of baseboard management controllers, comprising:
an acquisition module configured to acquire serial numbers of servers under test, and physical addresses of baseboard management controllers of the servers under test;
a storage module configured to store the serial numbers and the physical addresses; and
a test module configured to determine the baseboard management controllers according to the serial numbers and the physical addresses, and perform stress tests on the baseboard management controllers of the servers under test based on multi threads in one-to-one correspondence.

6. The system according to claim 5, wherein the acquisition module, which acquires the serial numbers of the servers under test and the physical addresses of the baseboard management controllers of the servers under test, operates any one of actions of:
acquiring the serial numbers and the physical addresses of the baseboard management controllers by a packet broadcast manner, through a dynamic host configuration protocol; and
receiving the serial numbers and the physical addresses of the baseboard management controllers transmitted from the servers under test, through a transmission control protocol.

7. The system according to claim 5, wherein the storage module installs preset software based on the serial numbers and the physical addresses of the baseboard management controllers.

8. The system according to claim 5, wherein the stress test comprises any one of following actions:
performing a power-on/off stress test on the baseboard management controllers; and
performing a basic information access stress test on the baseboard management controllers.

9. A computer-readable storage medium, storing a computer program which is executable for a processor to perform the method according to one of claims 1 to 4.

10. A device for stress test of baseboard management controllers, comprising:
a storage medium configured to store a computer program; and
a processor connected to the storage medium, and configured to execute the computer program, to perform the method according to one of claims 1 to 4.
